(19) United States
(12) Patent Application Publication
(10) Pub. No.: US 2013/0210695 A1
(43) Pub. Date: Aug. 15, 2013

(54) USE OF BORIC ACID AND BORATE SALTS TO REDUCE THE FILMING AND STREAKING OF HARD SURFACE CLEANERS

(71) Applicants: Mick Bjelopavlic, Chandler, AZ (US); Kevin Hafer, Scottsdale, AZ (US)

(72) Inventors: Mick Bjelopavlic, Chandler, AZ (US); Kevin Hafer, Scottsdale, AZ (US)

(21) Appl. No.: 13/370,027

(22) Filed: Feb. 9, 2012

(51) Int. Cl. C11D 3/60

(52) U.S. Cl. 510/470; 510/499; 510/503; 510/502; 510/501; 510/490

(57) ABSTRACT

A substantially streak-free no-rinse hard surface cleaner composition is disclosed that comprises nonionic surfactant, alkanolamine; hydroxide and/or silicate builder, boric acid and/or borate salts, and water. The no-rinse cleaner is virtually streak-free by virtue of the added boric acid or borate. In a preferred embodiment, the substantially streak-free no-rinse cleaner comprises amine oxide surfactant, MEA, hydroxide, ethanol, sodium tetraborate pentahydrate and/or boric acid, and water. The present invention also comprises a method for improving the filming and streaking performance of alkaline no-rinse cleaners by the addition of borate salts and/or boric acid to the conventional cleaner.

### FIELD OF THE INVENTION

The present invention relates to hard surface cleaner compositions and in particular to alkaline spray-and-wipe cleaners that are substantially streak-free due to addition of boric acid and/or borate salts.

### BACKGROUND OF THE INVENTION

Consumer and commercial cleaners are available in many forms such as ready-to-use liquid spray cleaners in spray-and-wipe (i.e. no-rinse) and those that require rinsing, ready-to-use powdered cleansers, pressurized aerosols, cleaning and disinfecting wipes, and multi-purpose liquid and powder concentrates that are diluted prior to use. The ready-to-use spray-and-wipe trigger spray products include light-duty solvent cleaners for cleaning only lightly soiled surfaces such as windows, mirrors, chrome trim and the like. Many ready-to-use spray degreasers are available to remove light grease from stove tops and countertops. Some ready-to-use trigger spray cleaners that must be rinsed include powerful cleaners formulated to emulsify and saponify heavy kitchen grease. Bleach cleaners are designed to denature proteins and saponify the fats with high alkalinity. Cleaners may also sanitize or disinfect surfaces by delivering quaternary ammonium salts, chlorine bleach, or other antimicrobial active. Cleaners also include dilutable concentrates for light duty floor, wall, and countertop cleaning, specialized cleaning products useful on kitchen tile grout and worn sinks such as bleach containing stain removers (such as Clorox® Clean-Up®), and dry and creme scouring cleansers (such as Barkeepers Friend®, Comet® Cleanser, Soft Scrub with Bleach®, and the like).

A truly ready-to-use, spray-and-wipe hard surface cleaner that has superior cleaning performance yet is substantially streak-free in use, has been somewhat of an aspiration, although many retail marketers claim their products deliver such broad applicability. Arguably, development of a streak-free spray-and-wipe cleaner that actually cleans is problematic because any builders that increase saponification of greasy soils, and many surfactants used to increase emulsification of greasy soils, will almost certainly increase filming and streaking. The reason is that any inorganic salt and many surfactants will dry as a visible residue, and incorporation of these typical detergent ingredients at levels required to promote cleaning will necessarily result in more residue left on hard surfaces.

The patent literature does contain a number of references that disclose streak-free spray-and-wipe cleaner compositions. Some of the more relevant prior art is discussed herein.

PCT Application Publication No. WO2011/051161 (Karsten et al.) discloses substantially streak-free cleaner compositions comprising a glycolipid biosurfactant and at least one solvent.

U.S. Pat. No. 7,314,852 (Cummings et al.) discloses substantially streak-free cleaner compositions comprising an ethylene glycol ether HO—(CH₂CH₂O)ₙ—R, where n is the integer 1 or 2, and R is C₁-C₁₀ alkyl; an N—(C₁-C₁₂)alkyl pyrrolidone; and a surfactant chosen from amphoteric surfactants and alkylpolyglycoside surfactants.

U.S. Application Publication No. 2009/0264330 (Bruckner et al.) discloses a substantially streak-free cleaner composition comprising a fatty alcohol sulfate and/or sarcosinate surfactant; isopropyl alcohol; and a butyl glycol.

U.S. Pat. No. 6,489,285 (Faber) discloses a substantially streak-free cleaner comprising nonionic surfactant; quaternary; a glycol ether solvent; a terpene; and water. The nonionic surfactant is selected from the group of alkylpolyglycosides and amine oxide surfactants. The composition may also include from 0.1 to 1% alkali metal carbonate. In Col. 9, Lines 30-32 of the '285 patent, the inventors disclose that “[w]hen builders are incorporated, they are present in minor amounts keeping in mind the intent of the present invention to provide a streak-free composition.” This statement reflects what is well known to one skilled in the art of detergent formulation. Namely, inorganic materials will make filming and streaking worse.

U.S. Pat. No. 5,750,482 (Cummings) discloses a non-streaking glass cleaner comprising surfactant; ethylene glycol monohexyl ether; and an organic solvent mixture comprising both high-boiling and low-boiling co-solvents.

U.S. Pat. No. 6,350,727 (Flower) discloses an aqueous streak-free cleaner composition comprising an EDTA salt; an alkylpolyglycoside surfactant; an alkyl ether carboxylate surfactant; and up to 0.5% alkyl ethoxylate surfactant.

U.S. Pat. No. 5,432,534 (Skrobala et al.) discloses a streak-free wipe, where the liquid composition saturated in the wipe substrate is comprised of an aqueous mixture of monohydric C₁-C₆ alcohol; an alkylpolyglycoside surfactant; and preservative.

U.S. Pat. No. 5,126,068 (Burke et al.) discloses an essentially streak-free hard surface cleaner composition comprising a nonionic EO/PO or EO/BO alcohol; a pH adjuster (apparently sodium hydroxide in the examples); an organic solvent such as glycol ether; and an “additive” described as acrylic polymer, maleic anhydride/methyl vinyl ether copolymer, or maleic acid/olefin copolymer. The pH adjuster is added from about 0.1 to about 0.5% to make the compositions alkaline.

PCT Application Publication No. WO2010/101864 (Shimmin et al.) discloses a streak-free wipe where the substrate is saturated with an aqueous solution of alkylpolyglycoside surfactant, C₂-C₄ alcohol, and from 0.05 to 2.0% glycerin. The examples labeled D, E, F, and G in TABLE 1 of the publication incorporate 0.025 up to 0.172% citric acid. The citric acid appears to be the only component that would leave a residue and the amount added is obviously minimized.

PCT Application Publication No. WO2009/154652 (Shimmin et al.) discloses a streak-free hard surface cleaning composition comprising alkylpolyglycoside surfactant; C₂-C₄ alcohol; and optional dyes, builders, fatty acids, fragrance, colorants, glycerin, antifoaming agents, organic acids and preservatives. The examples in the reference only use minimal levels of citric acid as a buffer/builder.

PCT Application Publication No. WO2008/079718 (Kong et al.) discloses a streak-free wipe where the substrate is saturated with an aqueous solution of alkylpolyglycoside surfactant; glycol ether solvent; C₂-C₄ alcohol; and a quaternary biocide. The example compositions include only very small amounts of citrate salts.

U.S. Pat. No. 7,345,015 (Kong et al.) discloses a streak-free wipe where the substrate is saturated with an aqueous solution of alkypolyglycoside surfactant; propylene glycol ether solvents; quaternary; C₂-C₄ alcohol; where the ether/alcohol ratio is optimized at 0.02 to 1. The exemplary compositions do not include substantial amounts of any builder/buffer.

U.S. Pat. No. 7,148,187 (Simon et al.) discloses a streak-free cleaner composition comprising lactic acid; anionic surfactant; nonionic surfactant; a water-immiscible solvent; and a water-miscible solvent.

U.S. Pat. No. 7,414,017 (Kong et al.) discloses a streak-free cleaner composition comprising alkylpolyglycoside surfactant; C₂-C₄ alcohol; and propylene glycol ether.

Lastly, U.S. Pat. No. 5,929,007 (Feng) discloses a hard surface cleaner composition useful for removing heavy dried-on food soils. As such, the inventive cleaners are not spray-and-wipe (i.e. no-rinse) products. The '007 compositions comprise amine oxide surfactant; an alkalinity source; glycol ether solvent; optional chelant; and optional alkanolamine. The alkalinity source includes the possible use of caustic together with borate. The higher levels of alkali builders are indicative of a cleaning product that will be rinsed and where filming and streaking is a non-issue.

What is clearly lacking in the prior art is a ready-to-use spray-and-wipe cleaner that can be used to clean a wide variety of soiled surfaces and that also leaves virtually no visible residue when wiped away without rinsing. In particular, there are no obvious ingredients, especially no inexpensive, common detergent ingredients such as inorganic acids or salts, which may be added to alkaline spray-and-wipe cleaners to improve filming and streaking characteristics.

### SUMMARY OF THE INVENTION

It has now been remarkably discovered that by including boric acid and/or borate salts in alkaline spray-and-wipe cleaners, streaking and filming is dramatically improved. Heretofore it was common knowledge that inorganic materials will make streaking and filming worse.

In an exemplary embodiment of the present invention, from about 0.1 to about 1.0 wt. % of boric acid or borate salt dramatically improves the filming and streaking characteristics of an alkaline spray-and-wipe cleaner.

In another exemplary embodiment of the present invention, from about 0.25 to about 0.75 wt. % of boric acid or borate salt dramatically improves the streak-free properties of an alkaline spray-and-wipe cleaner.

In another exemplary embodiment of the present invention, a substantially streak-free spray-and-wipe cleaner comprises from about 0.1 to about 5.0 wt. % nonionic surfactant; from about 0.5 to about 2.0 wt. % alkanolamine; from about 0.01 to about 2.0 wt. % hydroxide builder; and from about 0.1 to about 1.0 wt. %, and preferably from about 0.25 to about 0.75 wt. %, boric acid and/or sodium tetraborate decahydrate.

In another exemplary embodiment of the present invention, a method is disclosed for improving the streaking and filming of a spray-and-wipe hard surface cleaner that comprises nonionic surfactant, alkanolamine, and hydroxide builder, said method comprising the step of adding from about 0.25 to about 0.75 wt. % of boric acid and/or borate salt to the hard surface cleaner.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Also, to better understand the present invention, a “spray-and-wipe” cleaner refers to a hard surface detergent composition that is in ready-to-use form (i.e. it does not require dilution with water or other solvents prior to use) and one that is not rinsed from the surface with water or any other solvent. However, “spray-and-wipe” cleaner does not imply that the present compositions must be “sprayed” onto the surface to be cleaned. It is preferred that the present compositions are sprayed through ordinary trigger sprayers equipped onto sprayer bottles rather than poured onto the surfaces to be cleaned. Therefore, the present compositions are applied to the hard surface to be cleaned without prior dilution (e.g. by pouring, dabbing, spraying, etc.) and the resulting soil/detergent mixture is wiped off from the surface using a suitable paper towel, cloth, sponge, etc. Alternatively a sponge or cloth may be saturated with the present compositions, the hard surface cleaned by wiping the saturated cloth across the surface, and then the excess product with soil may be wiped away with a clean cloth, sponge, towel, etc.

Also, it is important to realize that saturating a paper substrate, nonwoven or other textile with the spray-and-wipe compositions of the present invention in order to form a “wet-wipe” product having reduced streaking and filming is within the scope of the present invention.

Also for purposes of the present invention, the term “substantially streak-free” is obviously qualitative, and comes from the fact that human observers see little to no residue left behind on mirrored tiles when the tiles are wet with the present compositions and wiped. The term does not refer to what may be physically left behind on the mirrors. The term “substantially streak free” means that whatever may be left behind on the hard surface cannot be seen by the naked eye. For example, some films or amorphous residue may be transparent.

That being said, the present invention is a substantially streak-free spray-and-wipe hard surface cleaner composition comprising boric acid and/or borate salts present within a fairly narrow weight percent range. Heretofore, it was unknown and even counterintuitive that any inorganic material would improve the filming and streaking characteristics of a no-rinse hard surface cleaner, especially borates. The art has clearly taught for decades that inorganic substances dry to visible streaks, filming and crystalline spotting, and therefore such substances should be severely minimized or eliminated all together in any hard surface cleaners that are not to be rinsed.

In an exemplary embodiment of the present invention, from about 0.1 to about 1.0 wt. % boric acid and/or borate salts are added to alkaline spray-and-wipe hard surface cleaners to improve filming and streaking. In a more preferred embodiment, from about 0.25 to about 0.75 wt. % boric acid and/or borate salts are added to reach a substantially streak-free spray-and-wipe product. As such the present invention is also a method of improving the filming and streaking characteristics of a spray-and-wipe alkaline cleaner by the addition of these amounts of boric acid and/or borate salts to a base composition.

The present invention is also a substantially streak-free, alkaline spray-and-wipe cleaner that minimally comprises nonionic surfactant such as amine oxide, alkyl polyglycoside, alcohol ethoxylate, or a fatty acid alkanolamide; alkanolamine; builders and/or buffers excluding borates; and boric acid and/or borate salts. As will be discussed below, addition of boric acid may result to the formation of borate salts in situ in the alkaline compositions.

In other exemplary embodiments, the present streak-free spray-and-wipe detergent composition may comprise: other surfactants such as anionic surfactants and amphoteric surfactants; chelants; solvents; and, miscellaneous adjuvant such as dyes and other colorants, fragrance, encapsulated fragrance, and/or preservatives, and the like.

Boric Acid and/or Borate Salts

The remarkable find is that addition of boric acid and/or borate salts to alkaline spray-and-wipe cleaners actually reduces the amount of filming and streaking compared to the streaking and filming seen in the corresponding compositions not having any added boric acid and/or borate salts.

The present invention comprises boric acid and/or one or more borate salts. Boric acid is H₃BO₃, alternatively called hydrogen borate, and is obtained as colorless crystals or a white powder. It is soluble in water, and as a Lewis acid, boric acid interacts with water molecules to form tetrahydroxyborate ions. In alkaline conditions, these ions lead to borate. In other words, adding boric acid to an alkaline cleaning composition comprising sodium or potassium hydroxide is expected to lead to sodium or potassium borate. However, it is beyond the scope of the present invention to analyze the final hard surface cleaner compositions for borate content or to calculate how much borate is present when only boric acid is the chosen form of borate added to the compositions. If boric acid is added to the spray-and-wipe cleaners of the present invention, it is preferable that from about 0.1 to about 1.0 wt. % is added, based on the total weight of the cleaner composition. It is more preferred that from about 0.25 to about 0.75 percent by weight, based on the total weight of the cleaner composition. Most preferred is to use about 0.5% by weigh of boric acid (H₃BO₃), based on the total weight of the cleaner composition.

If a borate salt is added, instead of boric acid or in addition to boric acid, the borate used may be any form of borate salt, including Borax® (Hydrated Sodium Borate) Na₂O/2B₂O₃/1OH₂O, Kernite (Hydrated Sodium Borate) Na₂O/2B₂O₃/4H₂O, Colemanite (Hydrated Calcium Borate) 2CaO/3B₂O₃/5H₂O:CaO, Ulexite (Hydrated Sodium Calcium Borate) Na₂O/2CaO/5B₂O₃/16H₂O, Boracite 5MgO/MgCl₂/7B₂O₃, or mixtures thereof, with Borax® (sodium tetraborate decahydrate) being the preferred borate since it is readily available, reasonably priced, and easy to handle in manufacturing environments. Useful in the present invention is 10 Mol (30/70 mesh) Borax®, which is >99% white crystalline sodium tetraborate decahydrate. The compositions of the present invention may comprise from about 0.1 to about 1.0 wt. % of any of these borate salts, based on the total weight of the cleaner composition. More preferred is to use from 0.25 to 0.75 wt. % of borate salts, based on the total weight of the cleaner composition. Most preferred is to use about 0.5 wt. % sodium tetraborate decahydrate (i.e. Borax®), based on the total weight of the cleaner composition. Of course, a mixture of boric acid and any of these borate salts may be used, with the total amount from about 0.1 to about 1.0 wt. %. It is also beyond the scope of the present invention to determine the extent of ion exchange when adding any of these borate salts to an alkaline cleaner composition that may comprise sodium hydroxide, potassium hydroxide, or a mixture thereof.

Surfactant Components

As mentioned, the streak-free cleaners of the present invention necessarily include at least one nonionic surfactant. The nonionic surfactant for use in the present composition may be selected from the group consisting of amine oxides, alkyl polyglycosides, alcohol ethoxylates, fatty acid alkanolamides, and mixtures thereof.

Most preferred for use as the nonionic surfactant here is an amine oxide. Preferred amine oxides comprise the general formula R¹R²R³N⁺—O⁻, where R¹ is a C₆₋₃₀ alkyl, and R² and R³ are independently C₁₋₆ alkyl or hydroxyalkyl, and where R² and R³ may be the same or different group on the nitrogen. Preferred amine oxide surfactants include, but are not limited to, alkyl di-(hydroxy lower alkyl)amine oxides, alkylamidopropyl di-(lower alkyl)amine oxides, alkyl di-(lower alkyl)amine oxides, and/or alkylmorpholine N-oxides, wherein the alkyl group has 5-25 carbons and may be branched, straight-chain, saturated, and/or unsaturated. The most preferred amine oxides for the present invention include, but are not limited to, lauryl dimethyl amine oxide sold as aqueous solutions under the name Barlox® 12 from Lonza and Ammonyx® LO from Stepan. The amine oxide surfactants are preferably incorporated at a level of from about 0.1% to about 5% and most preferably from about 0.5% to about 3% by weight in the aqueous composition, based on the total weight of the cleaner composition.

Also preferred for use as a nonionic surfactant are the alkyl polyglycoside surfactants. The alkyl polyglycosides, (commonly referred to as APG's and also called alkyl polyglucosides if the saccharide moiety is glucose), are naturally derived, nonionic surfactants. The alkyl polyglycosides that may be used in the present invention are fatty ester derivatives of saccharides or polysaccharides that are formed when a carbohydrate is reacted under acidic conditions with a fatty alcohol through condensation polymerization. The APG's are typically derived from corn-based carbohydrates and fatty alcohols from natural oils found in animals, coconuts and palm kernels. Such methods for deriving APG's are well known in the art. The alkyl polyglycosides that are preferred for use in the present invention contain a hydrophilic group derived from carbohydrates and is composed of one or more anhydroglucose units. Each of the glucose units may have two ether oxygen atoms and three hydroxyl groups, along with a terminal hydroxyl group, which together impart water solubility to the glycoside. The presence of the alkyl carbon chain leads to the hydrophobic tail of the molecule.

When carbohydrate molecules react with fatty alcohol compounds, alkyl polyglycoside molecules are formed having single or multiple anhydroglucose units, which are termed monoglycosides and polyglycosides, respectively. The final alkyl polyglycoside product typically has a distribution of glucose units (i.e., degree of polymerization).

The APG's that may be used in the present invention preferably comprise saccharide or polysaccharide groups (i.e., mono-, di-, tri-, etc. saccharides) of hexose or pentose, and a fatty aliphatic group having 6 to 20 carbon atoms. Preferred alkyl polyglycosides that can be used according to the present invention are represented by the general formula, Gₓ-O—R¹, wherein G is a moiety derived from reducing saccharide containing 5 or 6 carbon atoms, e.g., pentose or hexose; R¹ is fatty alkyl group containing 6 to 20 carbon atoms; and x is the degree of polymerization of the polyglycoside, representing the number of monosaccharide repeating units in the polyglycoside. Generally, x is an integer on the basis of individual molecules, but because there are statistical variations in the manufacturing process for APG's, x may be a non-integer on an average basis when referred to particular APG's of use as an ingredient for the detersive composition of the present invention. For the APG's preferred for use herein, x preferably has a value of less than 2.5, and more preferably is between 1 and 2. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in polyglycosides. The fatty alkyl group is preferably saturated, although unsaturated fatty chains may be used. Generally, the commercially available polyglycosides have C₈ to C₁₆ alkyl chains and an average degree of polymerization of from 1.4 to 1.6.

Commercially available alkyl polyglycoside can be obtained as concentrated aqueous solutions ranging from 50 to 70% actives and are available from Cognis. Most preferred for use in the present compositions are APG's with an average degree of polymerization of from 1.4 to 1.7 and the chain lengths of the aliphatic groups are between C₈ and C₁₆. For example, one preferred APG for use herein has chain length of C₈ and C₁₀ (ratio of 45:55) and a degree of polymerization of 1.7. The cleaning composition preferably includes a sufficient amount of alkyl polyglycoside surfactant in an amount that provides a desired level of cleaning of soils found in homes and institutions. Preferably, the cleaning composition includes between about 0.1% and about 5% by weight alkyl polyglycoside surfactant and more preferably APG® 325N or Glucopon® 215 from Cognis at between about 0.5% and 3.0% by weight active alkyl polyglucoside surfactant to the total aqueous cleaner composition.

Also useful as nonionic surfactants in the present cleaning system are the ethoxylated and/or propoxylated primary alcohols having 9 to 18 carbon atoms and on average from 4 to 12 moles of ethylene oxide (EO) and/or from 1 to 10 moles of propylene oxide (PO) per mole of alcohol. Further examples are alcohol ethoxylates containing linear radicals from alcohols of natural origin having 12 to 18 carbon atoms, e.g., from coconut, palm, tallow fatty or oleyl alcohol and on average from 4 to about 12 EO per mole of alcohol. Somewhat useful as a nonionic surfactant in the present invention is the C₁₄-C₁₅ alcohol ethoxylate-7EO and the C₁₂-C₁₄ alcohol ethoxylate-12EO incorporated from about 1% to about 70%, for example at a level of from about 1% to about 20%. Nonionic ethoxylate surfactants that may find use herein include for example, Neodol® 91-6, Neodol® 45-7, Neodol® 25-9, or Neodol® 25-12 from Shell Chemical Company. Most preferred are Neodol® 45-7, which is a C₁₄-C₁₅ alcohol ethoxylate-7EO and Surfonic® L24-12, available from Huntsman, which is a C₁₂-C₁₄ alcohol ethoxylate-12EO surfactant (or the Neodol® 25-12 from Shell which is the petroleum feedstock derived material that is substantially similar in performance). Combinations of more than one alcohol ethoxylate surfactant may also be desired in the cleaner composition in order to maximize cleaning of various home and institutional surfaces. Alcohol ethoxylate nonionic surfactants are preferably incorporated at a level of from about 0.1% to about 5% by weight and most preferably from about 0.5% to about 3.0% by weight in the total aqueous composition.

The present spray-and-wipe cleaner composition may also include an amide type nonionic surfactant, for example alkanolamides that are condensates of fatty acids with alkanolamines such as monoethanolamine (MEA), diethanolamine (DEA) and monoisopropanolamine (MIPA), that have found widespread use in cosmetic, personal care, household and industrial formulations. Useful alkanolamides include ethanolamides and/or isopropanolamides such as monoethanolamides, diethanolamides and isopropanolamides in which the fatty acid acyl radical typically contains from 8 to 18 carbon atoms. Especially satisfactory alkanolamides have been mono- and diethanolamides such as those derived from coconut oil mixed fatty acids or special fractions containing, for instance, predominately C₁₂ to C₁₄ fatty acids. For most applications, alkanolamides prepared from trialkylglycerides are considered most practical due to lower cost, ease of manufacturing and acceptable quality. Of use in the present invention are mono- and diethanolamides derived from coconut oil mixed fatty acids, (predominately C₁₂ to C₁₄ fatty acids), such as those available from McIntyre under the brand name Mackamide®. Most preferred is Mackamide® CMA, which is coconut monoethanolamide available from McIntyre. If used, the amide surfactants are preferably incorporated at a level of from about 0.1% to about 5% and most preferably from about 0.5% to about 3% by weight in the aqueous composition.

The substantially streak-free spray-and-wipe cleaner composition of the present invention may optionally include anionic surfactants selected from the group consisting of disulfonates, alkyl sulfates, alkyl ether sulfates, various sulfonates, ether carboxylates, fatty acid soaps, and mixtures thereof.

The disulfonate surfactants that may find use in the present cleaning system include the alkyl diphenyloxide disulfonates having the general formula X⁺⁻O₃S—(C₆H₃R)—O—(C₆H₄)—SO₃⁻X⁺, where R is a linear or branched alkyl substituent with from about 6 to about 18 carbon atoms, and where both X⁺ are alkali metals, typically Na⁺, or both hydrogen (H), or a mixture of salts and protonated sulfonic acid groups. The most useful of these compounds for inclusion in the present invention are available from Pilot and include: Calfax® 6LA-75, where R is linear C₆ and both X are hydrogen; Calfax® 10L-45, where R is linear C₁₀ and both X are Na⁺; Calfax® 10LA-75, where R is linear C₁₀ and both X are hydrogen; Calfax® 12L-45, where R is linear C₁₂ and both X are Na⁺; Calfax® DB-45, where R is branched C₁₂ and both X are Na⁺; Calfax® DBA-70, where R is branched C₁₂ and both X are hydrogen; and, Calfax® 16L-35, where R is linear C₁₆ and both X are Na⁺. It should be understood that as with virtually all synthetic surfactants, these compounds are distributions of alkyl chain lengths and extent of sulfonation (e.g. averaging about 2 sulfonate groups). Placing any of these substances in strong alkali such as NaOH or KOH will cause exchange of ions (e.g. K⁺ for Nat or vice versa) and/or neutralization of existing protonated sulfonic acid groups (SO₃H) into the corresponding salt (e.g. resulting in SO₃⁻Na⁺ or SO₃⁻K⁺ groups). There is no certainty as to what particular salts may exist when any of these substances are used in alkaline compositions that include other ions because of ion exchange. The alkyl diphenyloxide disulfonate compounds function as detergents and hydrotropes. The most useful disulfonate for the present invention is disodium dodecyl diphenyloxide disulfonate, available from Pilot as Calfax® DB-45, although use of Calfax® DBA-70 in a highly caustic environment (e.g. KOH, or NaOH) achieves the same result although the counterions may be sodium, potassium, or mixed. Most preferred is to incorporate from about 0.5% to about 1.5% active disulfonate in the present cleaning system. For example, 1.1% of 45% active Calfax® DB-45 will deliver 0.5% active disulfonate in the composition and 3.33% Calfax® DB-45 will deliver 1.5% active disulfonate.

The alkyl sulfates, also known as alcohol sulfates, may also find use in the present invention, and used in combination with the above mentioned nonionic surfactant(s). The preferred alkyl sulfate anionic surfactants have the general formula R—O—SO₃⁻M⁺ where R is an alkyl chain of from about 8 to 18 carbon atoms and M is an alkali or alkaline earth metal. These materials may also be denoted as the sulfuric monoesters of C₈-C₁₈ alcohols, wherein the preferred examples include sodium n-octyl sulfate, sodium decyl sulfate, sodium palmityl alkyl sulfate, sodium myristyl alkyl sulfate, sodium dodecyl sulfate, sodium tallow alkyl sulfate, sodium coconut alkyl sulfate, and mixtures of these surfactants, or of C₁₀-C₂₀ oxo alcohols, and those monoesters of secondary alcohols of this chain length. Also useful are the alk(en)yl sulfates of said chain length which contain a synthetic straight-chain alkyl radical prepared on a petrochemical basis, these sulfates possessing degradation properties similar to those of the corresponding compounds based on fatty-chemical raw materials. From a purely detersive standpoint, C₁₂-C₁₆-alkyl sulfates, C₁₂-C₁₅-alkyl sulfates, and also C₁₄-C₁₅ alkyl sulfates, are all preferred. The most preferred alkyl sulfates have a shorter chain length and may function more as a hydrotrope in the composition rather than a detersive surfactant. Most preferred is to use sodium n-octyl sulfate (sodium capryl sulfate) from Cognis sold under the trade name of Texapon® 842. The preferred level of alcohol sulfate in the present invention is from about 0.1% to about 5%. Most preferred is from about 0.1% to about 2%. The most preferred ratio of sulfate to disulfonate, when these anionic surfactants are used together in the present invention, is from about 1:1 to about 2:1.

The present cleaning system may include other anionic surfactants such as sulfonates. Preferred surfactants of the sulfonate type are C₉₋₁₃ alkylbenzenesulfonates, olefinsulfonates, and hydroxyalkanesulfonates, as are obtained, for example, from C₁₂₋₁₈ monoolefins having a terminal or internal double bond by sulfonating with gaseous sulfur trioxide followed by alkaline or acidic hydrolysis of the sulfonation products. Sulfonate surfactants that are preferred for use in the present invention include the alkyl benzene sulfonate salts. Suitable alkyl benzene sulfonates include the alkali metal and alkaline earth salts of straight or branched-chain alkyl benzene sulfonic acids. Alkyl benzene sulfonic acids useful as precursors for these surfactants include decyl benzene sulfonic acid, undecyl benzene sulfonic acid, dodecyl benzene sulfonic acid, tridecyl benzene sulfonic acid, tetrapropylene benzene sulfonic acid and mixtures thereof. Preferred sulfonic acids, functioning as precursors to the alkyl benzene sulfonates useful for compositions herein, are those in which the alkyl chain is linear and averages about 8 to 16 carbon atoms (C₈-C₁₆) in length. Examples of commercially available alkyl benzene sulfonic acids useful in the present invention include Calsoft® LAS-99, Calsoft® LPS-99 or Calsoft® TSA-99 marketed by Pilot Chemical. Most preferred for use in the present invention is sodium dodecylbenzene sulfonate, available commercially as the sodium salt of the sulfonic acid, for example Calsoft® F-90, Calsoft® P-85, Calsoft® L-60, Calsoft® L-50, or Calsoft® L-40. Also of possible use in the present invention are the ammonium salts, lower alkyl ammonium salts, and the lower alkanol ammonium salts of linear alkyl benzene sulfonic acid, such as triethanol ammonium linear alkyl benzene sulfonate including Calsoft® T-60 sold by Pilot Chemical. If incorporated as an optional anionic surfactant in the present invention, the preferred level of sulfonate is from about 0.1% to about 10%. Most preferred is to use sodium dodecylbenzene sulfonate at a level of from about 0.1% to about 2%. Also of use in the present invention are the xylene, cumene, and naphthalene sulfonates that function more as hydrotropes rather than detersive surfactants. Most preferred for use as hydrotropes in the present compositions are sodium xylene sulfonate and sodium cumene sulfonate, at from about 0.01% to about 2% by weight to the total composition. Hydrotropes such as these sulfonates have been known to mitigate filming and streaking in alkaline cleaning compositions.

Also with respect to the optional anionic surfactants useful in the cleaning composition of the present invention, the alkyl ether sulfates, also known as alcohol ether sulfates, are preferred. Alcohol ether sulfates are the sulfuric monoesters of the straight chain or branched alcohol ethoxylates and have the general formula R—(CH₂CH₂O)ₓ—SO₃M, where R—(CH₂CH₂O)ₓ— preferably comprises C₇-C₂₁ alcohol ethoxylated with from about 0.5 to about 9 mol of ethylene oxide (i.e. x=0.5 to 9 EO), such as C₁₂-C₁₈ alcohols containing from 0.5 to 9 EO, and where M is alkali metal or ammonium, alkyl ammonium or alkanol ammonium counterion. Preferred alkyl ether sulfates include C₈-C₁₈ alcohol ether sulfates with a degree of ethoxylation of from about 0.5 to about 9 ethylene oxide moieties and most preferred are the C₁₂-C₁₅ alcohol ether sulfates with ethoxylation from about 4 to about 9 ethylene oxide moieties, with 7 ethylene oxide moieties being most preferred. It is understood that when referring to alkyl ether sulfates, these substances are already salts (hence designated “sulfonate”), and most preferred and most readily available are the sodium alkyl ether sulfates (also referred to as NaAES). Commercially available alkyl ether sulfates include the CALFOAM® alcohol ether sulfates from Pilot Chemical, the EMAL®, LEVENOL® and LATEMAL® products from Kao Corporation, and the POLYSTEP® products from Stepan, however most of these have fairly low EO content (e.g., average 3 or 4-EO). Alternatively the alkyl ether sulfates for use in the present invention may be prepared by sulfonation of alcohol ethoxylates (i.e., nonionic surfactants) if the commercial alkyl ether sulfate with the desired chain lengths and EO content are not easily found, but perhaps where the nonionic alcohol ethoxylate starting material may be. For example, sodium lauryl ether sulfate (“sodium laureth sulfate”, having about 3 ethylene oxide moieties) is very readily available commercially and quite common in shampoos and detersives, however, this is not the preferred level of ethoxylation for use in the present invention for hard surface cleaning. Therefore it may be more practical to sulfonate a commercially available nonionic surfactant such as Neodol® 25-7 Primary Alcohol Ethoxylate (a C₁₂-C₁₅/7EO nonionic from Shell) to obtain the C₁₂-C₁₅/7EO alkyl ether sulfate that may have been difficult to source commercially. The preferred level of C₁₂-C₁₈/0.5-9EO alkyl ether sulfate in the present invention is from about 0.1% to about 10%. Most preferred is from about 0.1% to about 2%.

Fatty soaps may also be incorporated in the present cleaning composition as an optional anionic detersive component as these are particularly suitable to aid in fat and grease removal from hard surfaces. As used here, “fatty soap” means the salts of fatty acids. For example, the fatty soaps that may be used here have general formula R-0O₂M, wherein R represents a linear or branched alkyl or alkenyl group having between about 8 and 24 carbons and M represents a counterion such as sodium, potassium or magnesium, or ammonium or alkyl- or dialkyl- or trialkyl-ammonium or alkanol-ammonium cation. The fatty acid soaps suitable for emulsifying soils is preferably comprised of higher fatty acid soaps. That fatty acids that may be the feed stock to the fatty soaps may be obtained from natural fats and oils, such as those from animal fats and greases and/or from vegetable and seed oils, for example, tallow, hydrogenated tallow, whale oil, fish oil, grease, lard, coconut oil, palm oil, palm kernel oil, olive oil, peanut oil, corn oil, sesame oil, rice bran oil, cottonseed oil, babassu oil, soybean oil, castor oil, and mixtures thereof. Fatty acids can be synthetically prepared, for example, by the oxidation of petroleum, or by hydrogenation of carbon monoxide by the Fischer-Tropsch process. The fatty acids of particular use in the present invention are linear or branched and containing from about 8 to about 24 carbon atoms, preferably from about 10 to about 20 carbon atoms and most preferably from about 14 to about 18 carbon atoms. Preferred fatty acids for use in the present invention are tallow or hydrogenated tallow fatty acids and their preferred salts (soaps) are salts, such as sodium, potassium, or magnesium, or mixtures thereof. Other useful soaps are ammonium and alkanol-ammonium salts of fatty acids. The fatty acids that may be included in the present compositions will preferably be chosen to have desirable surface cleaning efficacy and foam. Of course, the fatty acids may be added as the free acids that are neutralized in situ in the composition by the alkalinity present. The preferred level of fatty soap in the present invention is from about 0.1% to about 10%. Most preferred is from about 0.1% to about 2%.

Additional anionic surfactants that may find use in the present invention include the alpha-sulfonated alkyl esters of C₁₂-C₁₆ fatty acids. The alpha-sulfonated alkyl esters may be pure alkyl ester or a blend of (1) a mono-salt of an alpha-sulfonated alkyl ester of a fatty acid having from 8-20 carbon atoms where the alkyl portion forming the ester is straight or branched chain alkyl of 1-6 carbon atoms and (2) a di-salt of an alpha-sulfonated fatty acid, the ratio of mono-salt to di-salt being at least about 2:1. The alpha-sulfonated alkyl esters useful herein are typically prepared by sulfonating an alkyl ester of a fatty acid with a sulfonating agent such as SO₃. When prepared in this manner, the alpha-sulfonated alkyl esters normally contain a minor amount, (typically less than 33% by weight), of the di-salt of the alpha-sulfonated fatty acid which results from saponification of the ester. Preferred alpha-sulfonated alkyl esters contain less than about 10% by weight of the di-salt of the corresponding alpha-sulfonated fatty acid.

The alpha-sulfonated alkyl esters, i.e., alkyl ester sulfonate surfactants, include linear esters of C₆-C₂₂ carboxylic acids that are sulfonated with gaseous SO₃. Suitable starting materials preferably include natural fatty substances as derived from tallow, palm oil, etc., rather than from petroleum sources. The preferred alkyl ester sulfonate surfactants, especially for a detersive composition for the present invention, comprise alkyl ester sulfonate surfactants of the structural formula R³—CH(SO₃M)-CO₂R⁴, wherein R³ is a C₈-C₂₀ hydrocarbon chain preferably naturally derived, R⁴ is a straight or branched chain C₁-C₆ alkyl group and M is a cation which forms a water soluble salt with the alkyl ester sulfonate, including sodium, potassium, magnesium, and ammonium cations. Preferably, R³ is C₁₀-C₁₆ fatty alkyl, and R⁴ is methyl or ethyl. Most preferred are alpha-sulfonated methyl or ethyl esters of a distribution of fatty acids having an average of from 12 to 16 carbon atoms. For example, the alpha-sulfonated esters Alpha-Step® BBS-45, Alpha-Step® MC-48, and Alpha-Step® PC-48, all available from the Stepan Co. of Northfield, Ill., may find use in the present invention. Alpha-sulfonated fatty acid ester surfactants may be used at a level of from about 0.1% to about 5% and most preferably at a level of from about 0.1% to about 2% by weight in the detersive composition.

Lastly, the cleaner compositions of the present invention may include ether carboxylates or (ether carboxylic acids neutralized in situ to carboxylates) as an additional anionic ingredient, having the general formula: R—[OCH₂CH₂]ᵤ-[O(CH₂)ₓCH(R′)(CH₂)_{y}—CH(R″)(CH₂)_{z}]ᵥ—[OCH₂CH₂]_{w}—OCH₂—COOM, where R is a hydrocarbon radical containing 6 to 28 carbon atoms; u and v may be the same or different and from about 0 to 30, u being 0 where v is 0; w is from about 1 to 30, the sum of u, v, and w being less than or equal to 30; x, y and z are independent of one another and are either 0 or 1; R′ and R″ may independently be hydrogen, methyl or ethyl; the sum of x, y, and z being >0 where R′═R″═H; M is an alkali metal or alkaline earth metal (for the ether carboxylates) or hydrogen (for the ether carboxylic acids that will be neutralized in the alkaline composition). Ether carboxylates corresponding to this general chemical formula may be obtained by alkoxylation, (e.g. ethoxylation, propoxylation, or mixture of the two processes). The sum of u, v, and w in the formula above represents the total degree of alkoxylation of the ether carboxylate. Although on a molecular level the numbers u, v and w and the total degree of alkoxylation can only be integers, including zero, on a macroscopic level they are average values and usually in the form of non-integers. Referring still to this general formula for ether carboxylates/carboxylic acids, R may be linear or branched, acyclic or cyclic, saturated or unsaturated, aliphatic or aromatic, but is preferably a linear or branched, acyclic C₆-C₂₂ alkyl or alkenyl group, or a C₁-C₂₂ alkyl phenyl group, and more particularly a C₈-C₁₈ alkyl or alkenyl group, or a C₄-C₁₆ alkyl phenyl group, and more preferably a C₁₀-C₁₆ alkyl group; the sum of u, v, and w is preferably from about 2 to about 20, and more preferably from about 3 to about 17, and most preferably from about 5 to about 15; the sum of x, y and z is preferably no greater than 2, more preferably no greater than 1, and most preferably 0; R′ and R″ are preferably hydrogen, methyl, or R′ is methyl and R″ is hydrogen; and, M is preferably lithium, sodium, potassium, calcium or magnesium, of which sodium and potassium are most preferred. Preferred ether carboxylates for the present cleaning system include the mixed adducts of propylene oxide (where v is greater than 0; x, y, and z are each 0; R′═H, R″=Me R′=Me, R″═H) and ethylene oxide (u is 0, or u is greater than 0) corresponding to the formula: R—[OCH₂CH₂]ᵤ—[OCH(R′)CH(R″)_{z}]ᵥ—[OCH₂CH₂]_{w}—OCH₂—COOM, and more particularly those compounds in which u is 0, R′=Me and R″═H within the general formula: R—[OCH(CH₃)CH₂]ᵥ—[OCH₂CH₂]_{w}—OCH₂—COOM. Since the streak-free cleaner compositions according to the present invention are alkaline, the ether carboxylates may also be replaced by the ether carboxylic acids (M=H in any of the above formulas) which are neutralized in situ upon their introduction into the mixture. Accordingly, suitable ether carboxylates or corresponding ether carboxylic acids include the following representatives referred to by their INCI names (INCI: nomenclature for raw materials according to the International Cosmetic Ingredient Dictionary, 7th Edition, published by the Cosmetic, Toiletry and Fragrance Association Inc. (CTFA), Washington D.C., USA): Butoxynol-5 Carboxylic Acid, Butoxynol-19 Carboxylic Acid, Capryleth-4 Carboxylic Acid, Capryleth-6 Carboxylic Acid, Capryleth-9 Carboxylic Acid, Ceteareth-25 Carboxylic Acid, Coceth-7 Carboxylic Acid, C9-11 Pareth-6 Carboxylic Acid, C11-15 Pareth-7 Carboxylic Acid, C12-13 Pareth-5 Carboxylic Acid, C12-13 Pareth-8 Carboxylic Acid, C12-13 Pareth-12 Carboxylic Acid, C12-15 Pareth-7 Carboxylic Acid, C12-15 Pareth-8 Carboxylic Acid, C14-15 Pareth-8 Carboxylic Acid, Deceth-7 Carboxylic Acid, Laureth-3 Carboxylic Acid, Laureth-4 Carboxylic Acid, Laureth-5 Carboxylic Acid, Laureth-6 Carboxylic Acid, Laureth-8 Carboxylic Acid, Laureth-10 Carboxylic Acid, Laureth-11 Carboxylic Acid, Laureth-12 Carboxylic Acid, Laureth-13 Carboxylic Acid, Laureth-14 Carboxylic Acid, Laureth-17 Carboxylic Acid, Magnesium Laureth-11 Carboxylate, Sodium-PPG-6-Laureth-6-Carboxylate, Sodium PPG-8-Steareth-7 Carboxylate, Myreth-3 Carboxylic Acid, Myreth-5 Carboxylic Acid, Nonoxynol-5 Carboxylic Acid, Nonoxynol-8 Carboxylic Acid, Nonoxynol-10 Carboxylic Acid, Octeth-3 Carboxylic Acid, Octoxynol-20 Carboxylic Acid, Oleth-3 Carboxylic Acid, Oleth-6 Carboxylic Acid, Oleth-10 Carboxylic Acid, PPG-3-Deceth-2 Carboxylic Acid, Sodium Capryleth-2 Carboxylate, Sodium Capryleth-9 Carboxylate, Sodium Ceteth-13 Carboxylate, Sodium C₉-C₁₁ Pareth-6 Carboxylate, Sodium C11-C15 Pareth-7 Carboxylate, Sodium C12-C13 Pareth-5 Carboxylate, Sodium C12-C13 Pareth-8 Carboxylate, Sodium C12-C13 Pareth-12 Carboxylate, Sodium C12-C15 Pareth-6 Carboxylate, Sodium C12-C15 Pareth-7 Carboxylate, Sodium C12-C15 Pareth-8 Carboxylate, Sodium C14-C15 Pareth-8 Carboxylate, Sodium Deceth-2 Carboxylate, Sodium Hexeth-4 Carboxylate, Sodium Isosteareth-6 Carboxylate, Sodium Isosteareth-11 Carboxylate, Sodium Laureth-3 Carboxylate, Sodium Laureth-4 Carboxylate, Sodium Laureth-5 Carboxylate, Sodium Laureth-6 Carboxylate, Sodium Laureth-8 Carboxylate Sodium Laureth-11 Carboxylate, Sodium Laureth-12 Carboxylate, Sodium Laureth-13 Carboxylate, Sodium Laureth-14 Carboxylate, Sodium-Laureth-17 Carboxylate, Sodium-Trudeceth-3 Carboxylate, Sodium Trideceth-6 Carboxylate, Sodium Trideceth-7 Carboxylate, Sodium Trideceth-8 Carboxylate, Sodium Trideceth-12 Carboxylate, Sodium Undeceth-5 Carboxylate, Trideceth-3 Carboxylic Acid, Trideceth-4 Carboxylic Acid, Trideceth-7 Carboxylic acid, Trideceth-15 Carboxylic Acid, Trideceth-19 Carboxylic Acid, and Undeceth-5 Carboxylic Acid. The most preferred ether carboxylates are the ethoxylated compounds corresponding to the general formula: R—[OCH₂CH₂]_{w}—OCH₂—COOM, in which R, w and M are as defined as above, R is preferably a C₁₀-C₁₆ alkyl group, w is preferably from about 3 to about 17, and M is preferably sodium ion. The most preferred ethoxylated anionic surfactants include the sodium lauryl ether carboxylates with a degree of ethoxylation from about 5 to 15, for example Sodium Laureth-6 Carboxylate (i.e. where w is 6) or Sodium Laureth-11 Carboxylate (i.e. where w is 11). A very useful blend for incorporation in the present cleaner composition is Akypo® TFC-S, available from Kao GmbH, which is a blend of Laureth-5-carboxylic acid and sodium n-octyl sulfate. When incorporated in the present invention, the ether carboxylate surfactant may be used from about 0.1% to about 2% by weigh active material to total weight of the composition.

As mentioned, the spray-and-wipe cleaner composition of the present invention may optionally include an amphoteric surfactant such as a betaine surfactant. Suitable betaines include, but are not limited to, the alkylbetaines, the alkylamidobetaines, the imidazoliniumbetaines, the sulfobetaines (INCI sultaines) and the phosphobetaines, conforming to the general formula R¹—[CO—X—(CH₂)ₙ]ₓ—N⁺(R²)(R³)—(CH₂)ₘ—[CH(OH)—CH₂]_{y}—Y⁻(I) in which: R¹ is a saturated or unsaturated C₆₋₂₂-alkyl radical, preferably C₈-C₁₈-alkyl radical, in particular a saturated C₁₀-C₁₆-alkyl radical, for example a saturated C₁₂₋₄₄-alkyl radical; X is NH, NR⁴ with the C₁₋₄-alkyl radical R⁴, O or S; n is a number from 1 to 10, preferably from 2 to 5, in particular 3; x is 0 or 1, preferably 1; R², R³ are each independently C₁₋₄-alkyl radicals, optionally hydroxyl-substituted, for example a hydroxyethyl radical, but in particular a methyl radical; m is a number from 1 to 4, in particular 1, 2 or 3; y is 0 or 1; and, Y is COO, SO₃, OPO(OR⁵)O or P(O)(OR⁵)O, where R⁵ is a hydrogen atom H or a C₁₋₄-alkyl radical. The alkyl- and alkylamidobetaines, betaines of the above general formula having a carboxylate group (Y⁻═COO⁻), are also called carbobetaines. Preferred amphoteric surfactants include the alkylbetaines of the general formula R¹—N⁺(CH₃)₂—CH₂COO⁻, the alkylamidobetaines of the general formula R¹—CO—NH—(CH₂)₃—N⁺(CH₃)₂—CH₂COO⁻, the sulfobetaines of the general formula R¹—N⁺(CH₃)₂—CH₂CH(OH)CH₂SO₃⁻, and the amidosulfobetaines of the general formula R¹—CO—NH—(CH₂)₃—N⁺(CH₃)₂—CH₂CH(OH)CH₂SO₃⁻(Id), in which R¹ is as defined in the preceding introduction to betaines. Examples of suitable betaines and sulfobetaines include, but are not limited to, the following compounds named in accordance with INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamidopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine. The preferred betaines for use in the present spray-and-wipe cleaner include cetyl betaine and/or lauryl betaine, and preferably in an amount of from about 0.01% to about 1% by weight actives to the total composition.

Alkanolamines

The substantially streak-free spray-and-wipe cleaners of the present invention include at least one alkanolamine. Preferred alkanolamines are chosen from the group consisting of monoethanolamine, monopropanolamine, diethanolamine, dipropanolamine, triethanolamine, 2-amino-2-methylpropanol, tri(hydroxylmethyl)amino methane (TRIS), 2-amino-2-ethyl-1,3-propanediol, 2-amino-2-methyl-1,3-propanol, N-methyl diethanolamide, 2-dimethylamino-2-methylpropanol (DMAMP), 1,3-bis(methyl-amine)cyclohexane, 1,3-diamino-propanol, N,N′-tetra-methyl-1,3-diamino-2-propanol, N,N-bis(2-hydroxyethyl)glycine, N-tris(hydroxymethyl)methyl glycine, and mixtures thereof. Any of these alkanolamines in any combination are suitable for use in the present cleaner composition. Preferably, the alkanolamine(s) is/are present in the composition at from about 0.1 to about 5.0 wt. %, and more preferably from about 0.5 to about 2.0 wt. %, based on the total weight of the cleaner composition. Most preferred is to use only monoethanolamine (MEA) at from about 0.5 to about 2.0% by weight, based on the total weight of the composition.

Builders

The cleaning system preferably includes a builder that can add even additional alkalinity to the cleaning composition beyond what is incorporated from the alkanolamine. Builders herein are defined to exclude borates, so that there is no confusion when disclosing the inventiveness of adding borate to a composition that includes builder such as hydroxide. With that exclusion in mind, builders for use in the present hard surface cleaners are selected from the group consisting of hydroxides, carbonates, bicarbonates, silicates, zeolites, phosphates, citrates, and mixtures thereof, at a level of from about 0.001 to about 5% by weight active material, and most preferably from about 0.01 to about 2% by weight active material, based on the total weight of the composition. More useful in the present invention is sodium, potassium, or magnesium hydroxide, and optionally any sodium, potassium, or magnesium, or mixed silicate, or combinations thereof. As mentioned, borate, often disclosed in the prior art as a builder, is treated separately above in the context of a filming and streaking reducer.

The preferred silicate is an alkali metal silicate salt (the alkali metal salts of silicic acid) with the sodium and potassium silicate salts being the most preferred. The alkali metal silicates that are useful may be in a variety of forms that can be described by the general formula M₂O:SiO₂, wherein M represents the alkali metal and in which the ratio of the two oxides varies. Most useful alkali metal silicates will have a SiO₂/M₂O weight ratio of from about 1.6 to about 4. Preferred silicates include the Sodium Silicate Solutions from PQ Corporation, such as A®1647 Sodium Silicate Solution, a 46.8% active solution of sodium silicate having a SiO₂/Na₂O ratio of about 1.6 to about 1.8:1. Also of use in the compositions of the present invention are the potassium silicates, such as the Kasil® products from PQ Corporation. For example, Kasil®1 Potassium Silicate Solution is a 29.1% solution of potassium silicate having a SiO₂/K₂O ratio of about 2.5. It is preferable to use either sodium or potassium silicate at a level of from about 0.001% to about 1.0% in the compositions of the present invention. Also of use is sodium metasilicate and sodium silicate, such as the hydrous sodium silicate Britesil® C24 available from PQ Corporation.

It is preferred to incorporate any of the above mentioned builders at from about 0.01% to about 2% by weight active material in the detersive composition. Most preferred is to use sodium, potassium or magnesium hydroxide by itself as the builder, or a mixture of sodium hydroxide and sodium silicate as the builders at a total weight of actives of from about 0.01% to about 2% based on the total composition.

Buffer Component

The aqueous compositions for the present cleaning system may also comprise at least one organic or inorganic acid, mixtures of organic acids, mixtures of inorganic acids, or various combinations of organic and inorganic acids, in order to buffer the composition preferably above pH 7 and more preferably over 10, and to more reliably target a specific pH in manufacturing. The organic or inorganic acids for use as buffer in the present invention may be any known to those skilled in specialty chemicals and formulating cleaners, however, it is preferred to use at least one organic acid. With the proper selection of acidic buffer, there may be an added chelation effect. The acidic buffers that may find use in the present invention are selected from the group consisting of citric, lactic, oxalic, formic, nitric, sulfuric, sulfamic, phosphoric, hydrochloric, and mixtures thereof. Other organic and inorganic acids that may find use in the present invention are selected from the group consisting of maleic acid, sorbic acid, benzoic acid, p-hydroxybenzoic acid, glutaric acid, glycolic acid, ethylenediaminetetraacetic acid, polyphosphoric acid, aspartic acid, acetic acid, hydroxyacetic acid, propionic acid, hydroxypropionic acid, α-ketopropionic acid, butyric acid, mandelic acid, valeric acid, succinic acid, tartaric acid, malic acid, fumaric acid, adipic acid, and mixtures thereof. When used as an acidic buffer, any acid or combination of these acids are preferably used at a level of from about 0.001% to about 1.0% by weight to the total composition. Most preferred is to use only citric acid at from about 0.1% to about 1%, and more preferably at from about 0.2 to about 0.5% by weight, based on the total weight of the composition.

Chelating Agents

Chelating agents may be incorporated in the detersive compositions herein in amounts ranging from 0.001% to 20% by weight of the total composition, preferably from about 0.01% to about 5%. Particularly preferred for use herein are amino carboxylate chelants including salicylic acid, aspartic acid, glutamic acid, glycine, malonic acid, ethylene diamine tetraacetates (EDTA), diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanol-diglycines, propylene diamine tetracetic acid (PDTA) and methyl glycine diacetic acid (MGDA), both in their acid form, or in their alkali metal, ammonium, and substituted ammonium salt forms or partial salt forms. Particularly suitable amino carboxylates to be used herein are diethylene triamine penta acetic acid, propylene diamine tetracetic acid (PDTA) which is, for instance, commercially available from BASF under the trade name Trilon FS® and trisodium methyl glycine diacetic acid (MGDA) available from BASF under the trade name Trilon M®.

Other suitable chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®. Any of the above mentioned chelants may be used at from about 0.001% to about 20% by weight in the aqueous cleaner composition.

Water and Optional Solvents

As emphasized throughout, the cleaning compositions for use in the present cleaning system are aqueous, and in fact are preferably highly aqueous. With that said, the compositions herein will typically incorporate at least 50% by weight water, more preferably at least about 80% by weight, and most preferably at least 90% by weight of water, based on the total weight of the cleaner composition. Solvents may be included in these compositions along with the water as is typically seen in many spray cleaners, particularly glass cleaners. For example, monohydric alcohols, diols, and glycol ethers may be used in addition to water as co-solvent for the present compositions. Solvents, particularly the glycol ether solvents pioneered by Dow Chemical and Union Carbide, allow dissolution of soils directly, and assist the surfactants in soil removal. Furthermore, solvents improve drying time and shine when the cleaner is simply used as “spray-and-wipe.” Most preferred for use in the present invention are ethanol, isopropanol, propylene glycol, ethylene glycol n-butyl ether, propylene glycol n-butyl ether, propylene glycol mono-methyl ether, propylene glycol mono-phenyl ether, and propylene glycol dimethyl ether at from about 0.1% to about 5% by weight of the total composition. Most preferred is to include ethanol at from about 0.01 to about 2.0% by weight, based on the total weight of the composition.

Miscellaneous Adjuvant

The spray-and-wipe cleaners of the present invention may comprise adjuvant selected from the group consisting of dyes, pigments, colorants, fragrances, encapsulated fragrances, essential oils, deodorizing agents, odor absorbents, antimicrobial preservatives, antioxidants, uv inhibitors, oxidants, enzymes, thickeners, disinfectants, sterilants, sanitizers, and mixtures thereof.

The spray-and-wipe cleaner preferably includes a fragrance, in particular to mask any odors inherent in the ingredients. It is desirable to add sufficient fragrance that can be perceived at least while cleaning and to ensure storage stability for the scent. This may require; the use of substantive fragrances that have an increased longevity due to the nature of the fragrance components themselves (i.e. less volatile ingredients); the use of a fairly large amount of fragrance; and/or, the use of encapsulated fragrance(s), or combinations of these ideas. In the simplest embodiment, a fragrance typically used in cleaning compositions (e.g. lemon, orange, pine, floral, mint, etc.) may be incorporated in the detersive composition at from about 0.001% to about 5% by weight.

Encapsulated fragrances are well known in the art, and may find for use in the detersive composition of the present invention to give the composition a longer-lasting fragrance in storage. Encapsulation of fragrance has been described in many prior art references, including but not limited to; U.S. Pat. No. 7,338,928 to Lau et al.; U.S. Pat. No. 7,294,612 to Popplewell et al.; U.S. Pat. No. 7,196,049 to Brain et al.; U.S. Pat. No. 7,125,835 to Bennett et al.; U.S. Pat. No. 7,122,512 to Brain et al.; U.S. Pat. No. 7,119,057 to Popplewell et al.; U.S. Pat. No. 6,147,046 to Shefer et al.; U.S. Pat. No. 6,142,398 to Shefer et al.; U.S. Pat. No. 4,446,032 to Munteanu et al.; and, U.S. Pat. No. 4,464,271 to Munteanu, each of which is incorporated herein by reference. Fragrance encapsulation has been optimized and is available through various suppliers, most notably LIPO Technologies, Inc., Vandalia, Ohio, and Alco Chemical, Chattanooga, Tenn., (e.g. using Alcocap® natural polymers for encapsulation). Encapsulation is described thoroughly in “Microencapsulation: Methods and Industrial Applications”, Benita (Ed.), Marcel Dekker, Inc., New York, 1996. Fragrance microcapsules obtained from LIPO, Alco, or the fragrance houses, or as obtained through any of these published methods may be incorporated in the detersive compositions of the present cleaning system herein at from about 0.001% to about 0.05% by weight in the liquid composition.

The present spray-and-wipe cleaner may also contain colorants or dyes. Dyes are optional ingredients within the compositions of the present invention since color may or may not be visible through the sprayer bottle (e.g. if crystal clear, opaque, or colored plastic is blow-molded). Dyes may comprise pigments, or other colorants, chosen so that they are compatible with the other ingredients in the detersive composition, and not staining in the grouting between tiles, worn porcelain, and other porous surfaces that the present cleaning system may encounter. For example, a preferred colorant for use in the present invention is Liquitint® Green FS (from Milliken), at from about 0.001% to about 0.1% by weight, based on the total composition. Other non-limiting examples of dyes include C.I. Pigment Green #7, C.I. Reactive Green #12, F D & C Green #3, C.I. Acid Blue #80, C.I. Acid Yellow #17, Liquitint® Red MX, F D & C Yellow #5, Liquitint® Violet LS, Fast Turquise GLL, Liquitint® Blue MC, Liquitint® Blue HP, or mixtures thereof, which are also useful in the detersive compositions of the present invention.

Other adjuvant includes, but is not limited to, bleaching agents, oxidants, enzymes, cationic surfactants, thickeners, surface modifying polymers for hydrophilic modification of the hard surfaces for future easier cleaning, emulsifiers, bleach catalysts, bleach stabilizers, enzyme stabilizers, clays, other buffering agents, active salts, abrasives, preservatives (Neolone® Kathon® and the like), and anti-foaming agents (silicones and the like).

### Examples and Performance Testing

Exemplary spray-and-wipe cleaner compositions in accordance with the present invention are found in Table 1. All numerical entries in the table denote weight percent actives and are based on the total weight of the composition. That is, all the weight percentages of actives and the water must total to 100%. Superscripts following some of the wt. % entries in the table indicate which ingredient was used, given the two choices having corresponding superscripted numbers in the same row of the table. All of the formulas in TABLE 1 had a pH of greater than about 10.5.

TABLE 1
Spray-and-Wipe Cleaner Compositions

| Ingredient (weight % active) | 1 | 2 | 3 | 4 | 5 | 6 | 7 | 8 |
|---|---|---|---|---|---|---|---|---|
| Lauryl dimethylamine-N-oxide | 0.80 | 0.80 | 0.80 | 0.80 | 0.90 | 0.90 | 0.90 | 0.90 |
| Monoethanolamine | 1.35 | 1.35 | 1.35 | 1.35 | 1.35 | 1.35 | 1.35 | 1.35 |
| Borax ®¹ or Boric Acid² | 0.10¹ | 0.05¹ | 0.01¹ | 0.20¹ | 0 | 0.01¹ | 0.10¹ | 0.50¹ |
| NaOH³ or KOH⁴ | 0.22³ | 0.22³ | 0.22³ | 0.22³ | 0.20⁴ | 0.20⁴ | 0.20⁴ | 0.20⁴ |
| Citric Acid | 0.23 | 0.23 | 0.23 | 0.23 | 0.33 | 0.33 | 0.33 | 0.33 |
| Ethanol | 1.15 | 1.15 | 1.15 | 1.15 | 1.00 | 1.00 | 1.00 | 1.00 |
| Water, fragrance, misc. adjuvant | 96.15 | 96.20 | 96.24 | 96.05 | 96.22 | 96.21 | 96.12 | 95.72 |
| Total | 100.00 | 100.00 | 100.00 | 100.00 | 100.00 | 100.00 | 100.00 | 100.00 |

| Ingredient (weight % active) | 9 | 10 | 11 |
|---|---|---|---|
| Lauryl dimethylamine-N-oxide | 0.90 | 0.90 | 0.90 |
| Monoethanolamine | 1.35 | 1.35 | 1.35 |
| Borax ®¹ or Boric Acid² | 1.00¹ | 0.10² | 0.50² |
| KOH³ or NaOH⁴ | 0.20⁴ | 0.20⁴ | 0.20⁴ |
| Citric Acid | 0.33 | 0.33 | 0.33 |
| Ethanol | 1.00 | 1.00 | 1.00 |
| Water, fragrance, misc. adjuvant | 95.22 | 96.12 | 95.72 |
| Total | 100.00 | 100.00 | 100.00 |

Residue Testing

Streaking and filming testing was evaluated for the seven formulas marked 5-11 in TABLE 1 (only the potassium hydroxide formulas), and was conducted on mirrored tiles. Twenty five (25) drops of each test composition was evenly distributed across a pre-cleaned 12″×12″ mirror tile. Laboratory tissue wipes (VWR Cat. No. 82003-820) were folded in half four (4) times and used to wipe across the tile, first side to side, and then up and down. The wiped mirrors were then allowed to dry for 24 hours. Mirrored tiles were inspected and placed in ranking order (best to worst) by four observers. Each of the seven ranks (1-7) ranged from a visual rating of 1 (no visible residue, as opined by the observers) to 7 (very visible filming, as opined by the observers). The ranking results are shown in TABLE 2 below. Each entry number under each observer corresponds to a formula number from TABLE 1.

TABLE 2
Rating and Ranking of Test Mirror Tiles

| | Observer | | | |
|---|---|---|---|---|
| Film Residue | 1 | Observer 2 | Observer 3 | Observer 4 |
| 1 (none) | 8 | 8 | 8 | 8 |
| 2 | 11 | 11 | 11 | 11 |
| 3 | 7 | 7 | 7 | 7 |
| 4 | 10 | 9 | 9 | 6 |
| 5 | 6 | 6 | 6 | 5 |
| 6 | 5 | 5 | 5 | 9 |
| 7 (highly visible) | 9 | 10 | 10 | 10 |

The results showed that addition of 0.5 wt. % Borax® (Formula 8) or 0.5 wt. % boric acid (Formula II) consistently gave streak-free or virtually streak-free mirrors as opined by four separate panelists. Formula 7 (having 0.1 wt. % Borax®) begins to show filming and is consistently ranked in the third level of seven. The consistently lower ranking of Formula 5 (no borate), Formula 9 (1.0 wt. % Borax®) and Formula 6 (only 0.01 wt. % Borax®) shows that there is an optimal window where the streaking disappears. Too little borate (e.g. none at all up to about 0.1 wt. %), or too much borate (e.g. 1.0 wt. %), result in streaking, whereas about 0.5 wt. % of borate or boric acid results in a streak-free cleaner. This optimal range cannot have been predicted by the teaching in the prior art.

Interestingly enough, examination of the mirror tiles under a Nikon SMZ 1500 microscope showed that a residue was present on all tiles, even those ranked as the bnest and opined to have no visible residue at all. Although not wishing to be bound to any theory, it is certain that the added borate makes the inorganic/organic residue invisible, perhaps through crystal growth modification or some refractive phenomenon.

### Method for Mitigating Filming and Streaking in Alkaline Spray-and-Wipe Cleaners

As mentioned, the present invention also comprises a method for mitigating the filming and streaking of alkaline spray-and-wipe cleaners. The method comprises the steps of (a) blending an aqueous composition comprising at least one nonionic surfactant, at least one alkanolamine and at least one hydroxide builder in water to form an alkaline cleaner; and (b) adding to said cleaner 0.25 to 0.75 wt. % of a boron compound selected from the group consisting of sodium tetraborate decahydrate Na₂O/2B₂O₃/1OH₂O, Kernite (Hydrated Sodium Borate) Na₂O/2B₂O₃/4H₂O, Colemanite (Hydrated Calcium Borate) 2CaO/3B₂O₃/5H₂O:CaO, Ulexite (Hydrated Sodium Calcium Borate) Na₂O/2CaO/5B₂O₃/16H₂O, Boracite 5MgO/MgCl₂/7B₂O₃, boric acid, and mixtures thereof.

### Methods of Use

The streak-free clearer of the present invention may be applied to any hard surface, rubbed as necessary with a sponge or cloth, and then wiped away. The present invention will find particular use for the cleaning of reflective surfaces such as mirrors and polished metals. As mentioned above, the cleaners may be sprayed from conventional sprayer bottles equipped with trigger sprayers such as a Calmar® sprayer, or the cleaner may be poured, sprinkled, dosed or otherwise dispensed directly onto a surface to be cleaned without physical spraying involved. Alternatively, the present compositions may be used to wet a paper towel, cloth, sponge, towel, or nonwoven, and then the wet substrate used to clean and wipe away soil from hard surfaces. When using the present inventive cleaners, there is no need to rinse the surface with potable water or any need to polish the cleaned surface with a dry paper towel. The latter practice is sometimes necessary with retail glass cleaners.

We have thus described how boric acid and/or borate salts are used in a method to improve the streaking and filming residue seen in alkaline spray-and-wipe hard surface cleaners comprising nonionic surfactant, alkanolamine and hydroxide builder. We have also disclosed substantially streak-free hard surface cleaner compositions comprising boric acid and/or a borate salt; nonionic surfactant; alkanolamine; and hydroxide builder.

We claim:

1. A substantially streak-free ready-to-use hard surface cleaner composition comprising:
a. from 0.1 to 5 wt. % of at least one nonionic surfactant;
b. from 0.1 to 5 wt. % of at least one alkanolamine;
c. from 0.001 to 2 wt. % of a builder selected from the group consisting of hydroxides, silicates, and mixtures thereof;
d. at least 80 wt. % water; and
e. from 0.1 to 1 wt. % of a boron compound chosen from the group consisting of borate salts, boric acid, and mixtures thereof.

2. The composition of claim 1, wherein said nonionic surfactant is chosen from the group consisting of amine oxides, alkyl polyglycosides, alcohol ethoxylates, fatty acid alkanolamides, and mixtures thereof.

3. The composition of claim 1, wherein said borate salt is selected from the group consisting of Na₂O/2B₂O₃/1OH₂O, Na₂O/2B₂O₃/4H₂O, 2CaO/3B₂O₃/5H₂O:CaO, Na₂O/2CaO/5B₂O₃/16H₂O, 5MgO/MgCl₂/7B₂O₃, and mixtures thereof.

4. The composition of claim 1, wherein said alkanolamine is chosen from the group consisting of monoethanolamine, monopropanolamine, diethanolamine, dipropanolamine, triethanolamine, 2-amino-2-methylpropanol, tri(hydroxylmethyl) amino methane (TRIS), 2-amino-2-ethyl-1,3-propanediol, 2-amino-2-methyl-1,3-propanol, N-methyl diethanolamide, 2-dimethylamino-2-methylpropanol (DMAMP), 1,3-bis(methyl-amine)cyclohexane, 1,3-diamino-propanol, N,N′-tetra-methyl-1,3-diamino-2-propanol, N,N-bis(2-hydroxyethyl)glycine, N-tris(hydroxymethyl)methyl glycine, and mixtures thereof.

5. The composition of claim 1, further comprising a non-water solvent chosen from the group consisting of monohydric alcohols, diols, and glycol ethers.

6. The composition of claim 1, further comprising an organic acid.

7. A substantially streak-free no-rinse aqueous hard surface cleaner consisting essentially of:
a. from 0.5 to 3 wt. % of an amine oxide nonionic surfactant;
b. from 0.5 to 2 wt. % of monoethanolamine;
c. from 0.01 to 2 wt. % of an hydroxide;
d. from 0.01 to 2 wt. % of ethanol;
e. from 0.2 to 0.5 wt. % of an organic acid;
f. at least 90 wt. % water; and
g. from 0.25 to 0.75 wt. % of sodium tetraborate pentahydrate and/or boric acid.

8. A method for improving the filming and streaking performance of a no-rinse hard surface cleaner comprising nonionic surfactant, alkanolamine, hydroxide, and water, said method comprising the steps of:
a. forming an aqueous cleaner composition by blending the nonionic surfactant, alkanolamine, and hydroxide into water; and
b. adding to said cleaner composition from 0.25 to 0.75 wt. % sodium tetraborate pentahydrate and/or boric acid.
